(19) United States
(12) Patent Application Publication
(10) Pub. No.: US 2026/0064574 A1
(43) Pub. Date: Mar. 5, 2026

(54) SYSTEM AND METHOD TO ORCHESTRATE SECURE SOURCE CODE DEVELOPMENT IN DISTRIBUTED PROGRAMING ENVIRONMENT USING PROGRAMMER TELEMETRY AND DEVELOPER BEHAVIOR-FOCUS BASED TEST SUITE SELECTION

(71) Applicant: BANK OF AMERICA CORPORATION, CHARLOTTE, NC (US)

(72) Inventors: Shailendra Singh, Thane West (IN); A Likhitha, Hyderabad (IN); Manasa Krishna Gaddam, Hyderabad (IN); Satya Murthy Yenamandra, Hyderabad (IN)

(73) Assignee: BANK OF AMERICA CORPORATION, CHARLOTTE, NC (US)

(21) Appl. No.: 18/825,614

(22) Filed: Sep. 5, 2024

(51) Int. Cl. G06F 11/36

(52) U.S. Cl. CPC G06F 11/3688; G06F 11/3684

(57) ABSTRACT

Systems, computer program products, and methods are described herein for code development in a distributed programming environment using programmer telemetry and developer behavior-focus based test suite selection. The present disclosure is configured to capture telemetry data from developer interactions within an integrated development environment (IDE), preprocess and log the telemetry data for further analysis, analyze the data to discern developer behavior and focus levels using machine learning models, generate a focus score quantifying adherence to coding standards and security protocols, select and customize test suites based on the focus score, execute the test suites, and provide feedback to the developer. The system enhances code quality and security by dynamically adapting test suite selection based on real-time developer behavior, ensuring efficient and effective testing processes in a distributed environment.

### TECHNOLOGICAL FIELD

Example embodiments of the present disclosure relate to code development in distributed programing environment using programmer telemetry and developer behavior-focus based test suite selection.

### BACKGROUND

In recent years, the rise of distributed programming environments has transformed the way software is developed, with many developers working remotely or as freelancers. This shift has brought about several challenges, including maintaining focus and adherence to coding standards, ensuring security compliance, and efficiently managing the testing process. Traditional development environments struggle to provide adequate visibility into developer behavior and focus, leading to potential problems and inefficiencies. Developers may bypass important fault tolerance measures, such as coding standards, security checks, error handling, and naming conventions, which can compromise the quality and security of the software. Additionally, the lack of an intelligent method to select test cases based on developer behavior exacerbates these issues, often resulting in the execution of entire test suites, such as regression suites, in-sprint suites, and exploratory suites, thereby prolonging the testing process.

Applicant has identified a number of deficiencies and problems associated with code development in distributed programing environment using programmer telemetry and developer behavior-focus based test suite selection. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for code development in distributed programing environment using programmer telemetry and developer behavior-focus based test suite selection.

The present disclosure addresses the above challenges by introducing a system and method for orchestrating secure source code development in a distributed programming environment using programmer telemetry and developer behavior-focused test suite selection. The system captures telemetry data from developer interactions with integrated development environments (IDEs) and related tools, such as AI-coding assistants and monitoring tools. This data is preprocessed and analyzed to discern coding patterns, developer expertise, and potential anomalies. A behavior/focus score, ranging from 0 to 1, is generated to indicate the impact of developer behavior on coding quality. This score dynamically influences the selection of appropriate test suites, enhancing efficiency and accuracy in the testing process. Additionally, the system provides explanations for selected test cases and allows for their customization, thereby offering flexibility and adaptability. The continuous refinement of behavior/focus scores through iterative assessment further improves the system's effectiveness.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for code development in distributed programing environment using programmer telemetry and developer behavior-focus based test suite selection, in accordance with an embodiment of the disclosure;

FIG. 2 illustrates an exemplary machine learning (ML) subsystem architecture 200, in accordance with an embodiment of the invention;

FIGS. 3A and 3B illustrate a process flow for code development in distributed programing environment using programmer telemetry and developer behavior-focus based test suite selection, in accordance with an embodiment of the disclosure; and

FIG. 4 illustrates a high level process flow for code development in distributed programing environment using programmer telemetry and developer behavior-focus based test suite selection, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

As used herein, “code suggestions” may refer to automated recommendations provided by a system to assist a developer in writing or optimizing code. For example, code suggestions may include proposals for variable names, method signatures, code snippets, and syntax corrections that align with best practices or coding standards. These suggestions may be generated by integrated development environments (IDEs), code editors, or AI-powered coding assistants and may be used to enhance code readability, maintainability, and efficiency. In some embodiments, code suggestions may also include predictive completions or alternative code structures aimed at improving performance or security. The system may further prioritize or rank these suggestions based on the context of the developer's current work, previous coding patterns, or project-specific guidelines.

As used herein, “refactoring actions” may refer to the process of restructuring existing computer code without altering its external behavior to improve its internal structure. For example, refactoring actions may include renaming variables or methods, extracting methods, reducing code duplication, improving code modularity, and optimizing code for performance or maintainability. These actions may be suggested by an integrated development environment (IDE) or code editor during the coding process and are intended to make the codebase more understandable, reduce technical loss, and simplify future modifications. In some embodiments, refactoring actions may be triggered automatically by the system based on detected code smells, inefficiencies, or deviations from coding standards.

As used herein, “error-handling recommendations” may refer to automated advice or guidelines provided by a system to assist developers in managing and responding to errors within the code. For example, error-handling recommendations may include suggestions for implementing try-catch blocks, logging mechanisms, error messages, or recovery routines that address potential runtime exceptions or failures. These recommendations are typically aimed at ensuring that the application behaves predictably under error conditions, enhances user experience, and facilitates debugging. In some embodiments, the system may analyze the developer's code to identify areas where error handling is missing and propose specific code modifications or additions to mitigate the issue of unhandled exceptions.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

The present disclosure introduces a technology designed to enhance the development of secure source code in distributed programming environments. This technology leverages programmer telemetry and developer behavior-focused test suite selection to orchestrate the entire development process. It captures data from developers' interactions with their integrated development environments (IDEs) and other coding tools to provide real-time insights and feedback, ensuring adherence to coding standards and security protocols.

In distributed programming environments, developers often face numerous challenges, including distractions from social media, maintaining focus on development tasks, and adhering to coding standards and security checks. These challenges are exacerbated when developers work remotely as freelancers, making it difficult to monitor and ensure compliance with essential development practices. Consequently, developers may bypass crucial fault tolerance measures, leading to inefficiencies, increased issues, and a prolonged testing process. The lack of visibility into developer behavior and the inability to intelligently select test cases based on this behavior further complicates the situation, often resulting in the execution of entire test suites, which is time-consuming and resource-intensive.

The solution provided by the present disclosure can be explained in layperson's terms as follows: Imagine a smart assistant that watches over developers while they code, making sure they follow best practices and adhere to security guidelines. This assistant uses data from the developer's interactions with coding tools to understand their behavior and focus. Based on this understanding, it automatically chooses the most relevant tests to run, saving time and ensuring that the code is secure and efficient. This not only helps developers stay focused and productive but also streamlines the testing process, making it faster and more effective.

Accordingly, the present disclosure offers a comprehensive system for secure source code development in distributed programming environments by capturing telemetry data from developer interactions with IDEs and coding tools. This data is analyzed to understand coding patterns, developer expertise, and potential anomalies. A behavior/focus score is generated to reflect the developer's adherence to best practices. Based on this score, the system dynamically selects the most appropriate test suites for execution. Additionally, it provides explanations for the selected test cases and allows for their customization. The behavior/focus score is continuously refined through iterative assessment, thereby enhancing the system's accuracy and efficiency over time.

What is more, the present disclosure provides a technical solution to a technical problem. As described herein, the technical problem includes the challenge of ensuring secure and efficient code development in distributed programming environments, where developers are often remote and prone to distractions. The technical solution presented herein allows for the orchestration of secure source code development by leveraging programmer telemetry and behavior-focused test suite selection. In particular, this solution is an improvement over existing methods for managing distributed software development, as it (i) reduces the number of steps needed to ensure code quality and security, thereby conserving computing resources such as processing power, storage, and network bandwidth; (ii) provides a more accurate assessment of developer behavior, reducing the resources required to correct errors arising from less accurate methods; (iii) eliminates the need for manual intervention in test suite selection, improving speed and efficiency while conserving computing resources; and (iv) optimizes resource usage by dynamically selecting the most relevant test cases, thereby reducing network traffic and load on computing infrastructure. Furthermore, the technical solution described herein employs a rigorous, computerized process to perform tasks that were previously done manually or not at all, bypassing unnecessary steps and further conserving computing resources.

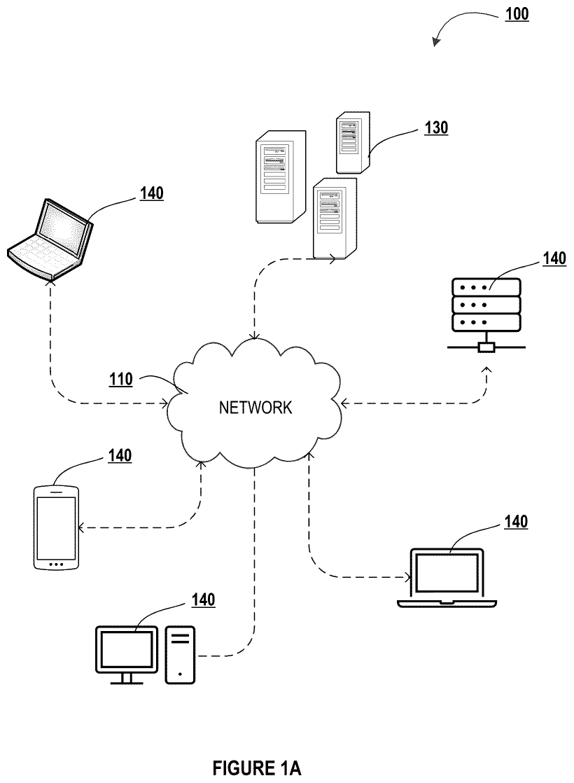

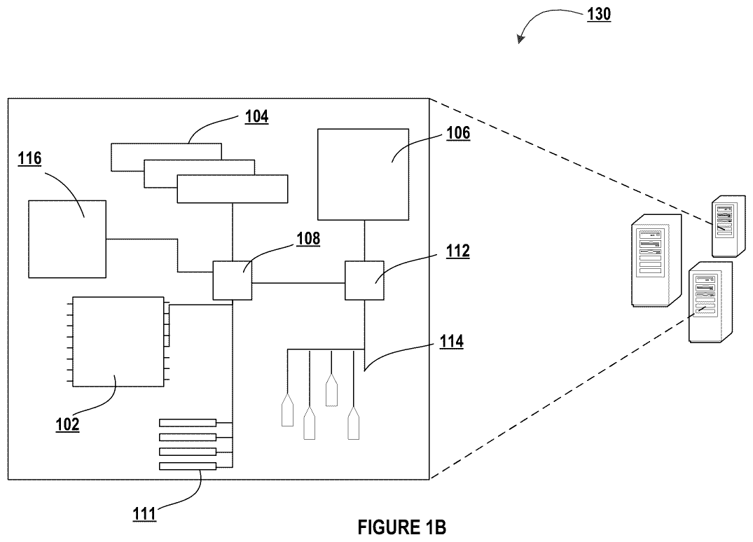

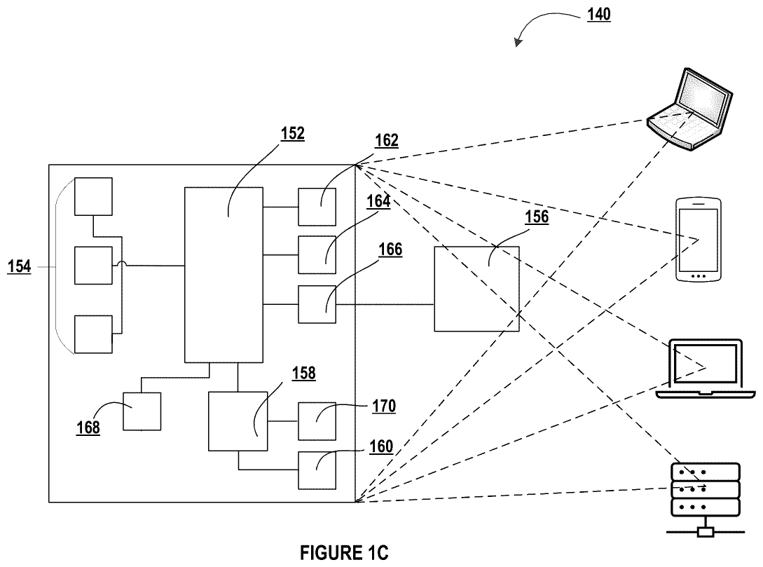

FIGS. 1A-1C illustrate technical components of an exemplary distributed computing environment 100 for code development in distributed programing environment using programmer telemetry and developer behavior-focus based test suite selection, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

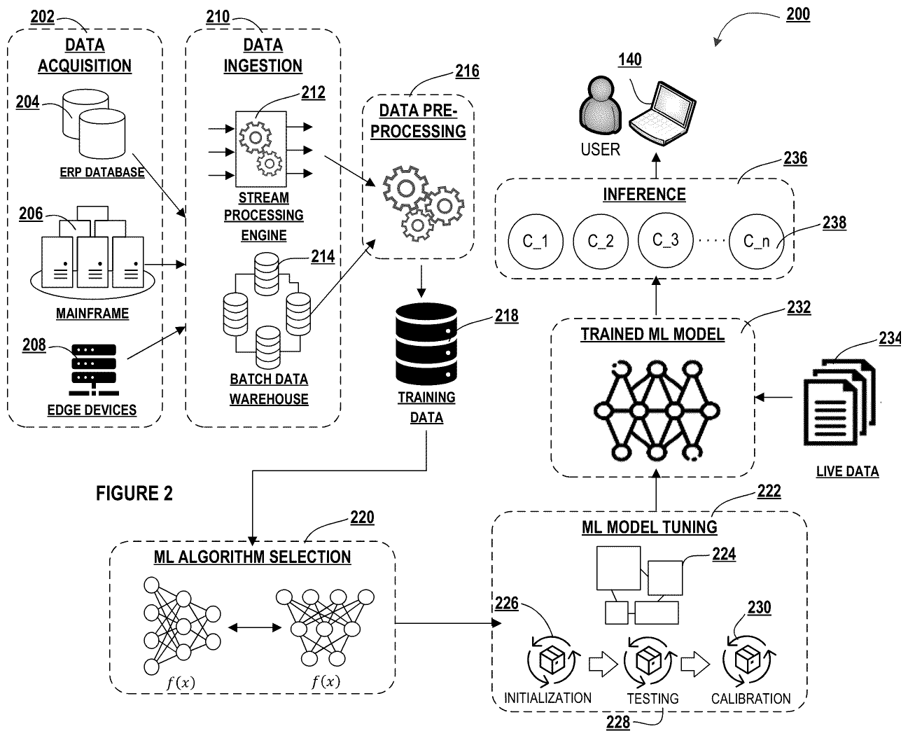

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and /r combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

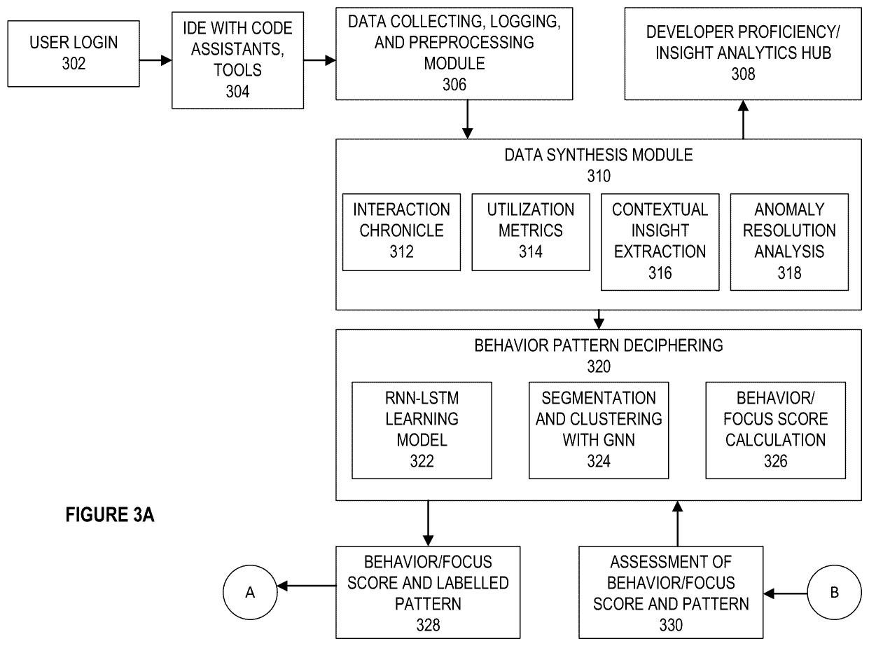

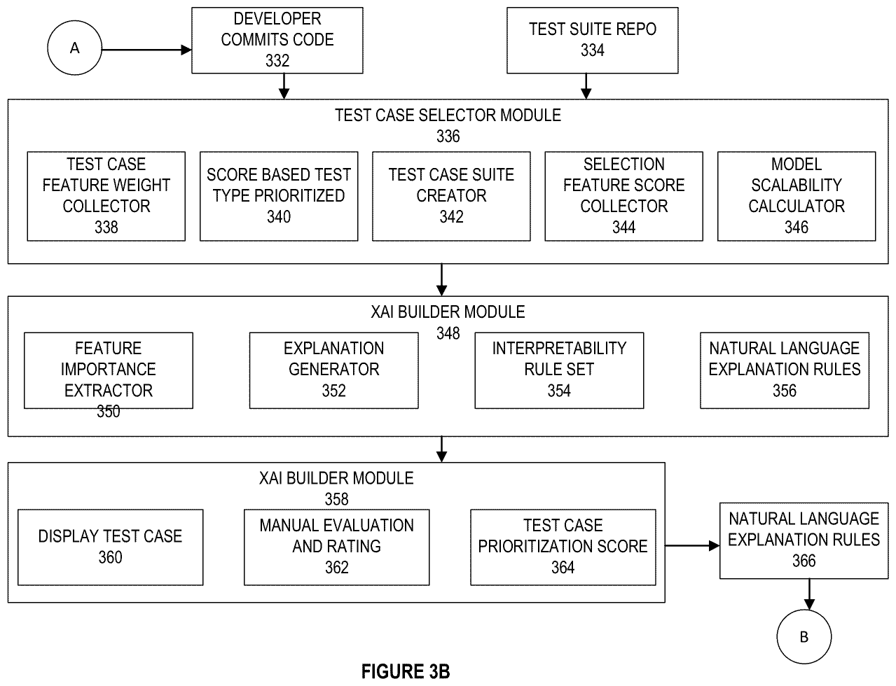

FIGS. 3A and 3B illustrate a process flow for code development in distributed programing environment using programmer telemetry and developer behavior-focus based test suite selection, in accordance with an embodiment of the disclosure. Referring now to FIG. 3A, a process flow is illustrated for the orchestration of secure source code development in a distributed programming environment using programmer telemetry and developer behavior-focused test suite selection, in accordance with an embodiment of the present disclosure. The process begins when a user logs into the system, as indicated by step 302. The user's login initiates the interaction between the developer and the integrated development environment (IDE), setting the stage for subsequent telemetry data collection.

Upon successful login, the user interacts with an IDE equipped with code assistants and tools, as depicted in step 304. This interaction involves various activities such as writing code, refactoring, and handling errors, all of which are monitored by the system. The code assistants may include AI-powered tools that offer real-time suggestions for variable naming, method calls, and other coding conventions, thereby aiding the developer in adhering to best practices and security standards.

The telemetry data generated from the developer's interactions is collected, logged, and preprocessed by a data collecting, logging, and preprocessing module at step 306. This module serves as a critical component of the system, ensuring that raw telemetry data is structured and filtered for noise reduction. The preprocessing step prepares the data for in-depth analysis by transforming it into a format that can be readily processed by the system's analytical modules.

Simultaneously, the system interfaces with a developer proficiency/insight analytics hub, shown at step 308, which provides contextual data regarding the developer's expertise, coding history, and prior performance. This hub plays a vital role in enriching the telemetry data with contextual information, which is necessary for accurate behavior assessment and test suite selection. The insights from this hub are integrated into the data preprocessing and synthesis processes, enhancing the overall precision of the system.

Following data collection and preprocessing, the structured data is passed to a data synthesis module at step 310. This module comprises several subcomponents, including the interaction chronicle 312, utilization metrics 314, contextual insight extraction 316, and anomaly resolution analysis 318. Each subcomponent performs specialized functions aimed at analyzing different aspects of developer behavior. For instance, the interaction chronicle logs coding patterns and behaviors over time, while utilization metrics assess the frequency and duration of tool usage. Contextual insight extraction derives deeper understanding from the data by correlating developer actions with their coding history, and anomaly resolution analysis identifies and flags any deviations from expected coding practices.

The synthesized data is then processed by the behavior pattern deciphering module at step 320. This module utilizes advanced machine learning models, including an RNN-LSTM learning model 322, which is adept at handling sequential data such as coding activities over time. The behavior pattern deciphering module also employs segmentation and clustering with GNN 324 to categorize developer actions into distinct patterns, enabling more granular analysis. Finally, the module calculates a behavior/focus score 326, which quantifies the developer's adherence to best practices, coding standards, and security protocols.

The calculated behavior/focus score is then combined with labeled pattern data at step 328 to form a comprehensive output that represents both the developer's current performance and the underlying behavior patterns. This output is critical for the subsequent selection of test suites, as it directly influences which tests are prioritized based on the developer's coding behavior and focus level. The labeled patterns and behavior/focus score are further assessed in step 330 to determine their impact on the overall development process, allowing for iterative refinement of the test suite selection criteria.

This detailed process flow, as illustrated in FIG. 3A, ensures that the system dynamically adapts to the developer's behavior, providing a tailored testing environment that enhances both code quality and security. The integration of telemetry data, contextual insights, and advanced machine learning techniques enables the system to make informed decisions about test suite selection, thereby streamlining the development process in distributed programming environments.

Furthermore, FIG. 3B illustrates the continuation of the process flow for secure source code development in a distributed programming environment using programmer telemetry and developer behavior-focused test suite selection, in accordance with an embodiment of the present disclosure. The process begins after the behavior/focus score and labeled pattern have been generated and assessed, as shown in step 332, where the developer commits code. This step represents the action of saving or finalizing the code in the repository, which triggers the system to proceed with the selection of appropriate test cases.

Upon the code commit, the system interacts with a test suite repository (test suite repo), as indicated in step 334. This repository contains a variety of test suites, including regression tests, security tests, and performance tests, which can be selected based on the specific needs of the code being committed. The test case selector module at step 336 is responsible for selecting the most appropriate test cases from the repository. This module comprises several subcomponents, each performing a critical function in the test selection process. The test case feature weight collector at step 338 gathers data on the relevance and importance of different test case features in relation to the committed code and the associated behavior/focus score. This data informs the subsequent prioritization of test types.

The score-based test type prioritizer at step 340 uses the behavior/focus score to determine which types of tests should be prioritized. For example, if the score indicates potential security issues, security-related test suites may be given higher priority. This step ensures that the most critical aspects of the code are tested first, thereby improving the efficiency and effectiveness of the testing process. Next, the test case suite creator at step 342 assembles the selected test cases into a comprehensive test suite tailored to the specific characteristics of the committed code. This suite is designed to thoroughly evaluate the code's adherence to best practices, security standards, and performance benchmarks. The selection feature score collector at step 344 then collects and analyzes scores related to the selected features of the test cases. This analysis helps in further refining the test suite by identifying which features are most critical for ensuring code quality.

To ensure that the selected test suite can be executed efficiently, the model scalability calculator at step 346 evaluates the scalability of the test cases. This evaluation considers factors such as the size of the codebase, the complexity of the tests, and the available computational resources, ensuring that the test suite can be scaled up or down as needed. The selected test cases and their associated explanations are then processed by the XAI (Explainable AI) builder module at step 348. This module plays a key role in making the test selection process transparent and understandable to developers and other stakeholders. The feature importance extractor at step 350 identifies which features of the code and test cases had the most significant impact on the selection process.

The explanation generator at step 352 creates detailed explanations for why certain test cases were selected, based on the behavior/focus score and other relevant data. This helps developers understand the reasoning behind the system's decisions and provides insights into areas where the code may need improvement. To further enhance the interpretability of the system's decisions, the interpretability rule set at step 354 is applied. These rules ensure that the explanations generated are consistent, clear, and aligned with industry best practices. Additionally, the natural language explanation rules at step 356 translate the system's decisions and explanations into easy-to-understand language, making the process more accessible to non-technical stakeholders. Once the explanations are generated, the system moves to the next stage, where the selected test cases are displayed, and their effectiveness is evaluated. This stage is crucial for refining the test suite and ensuring that it meets the desired quality standards.

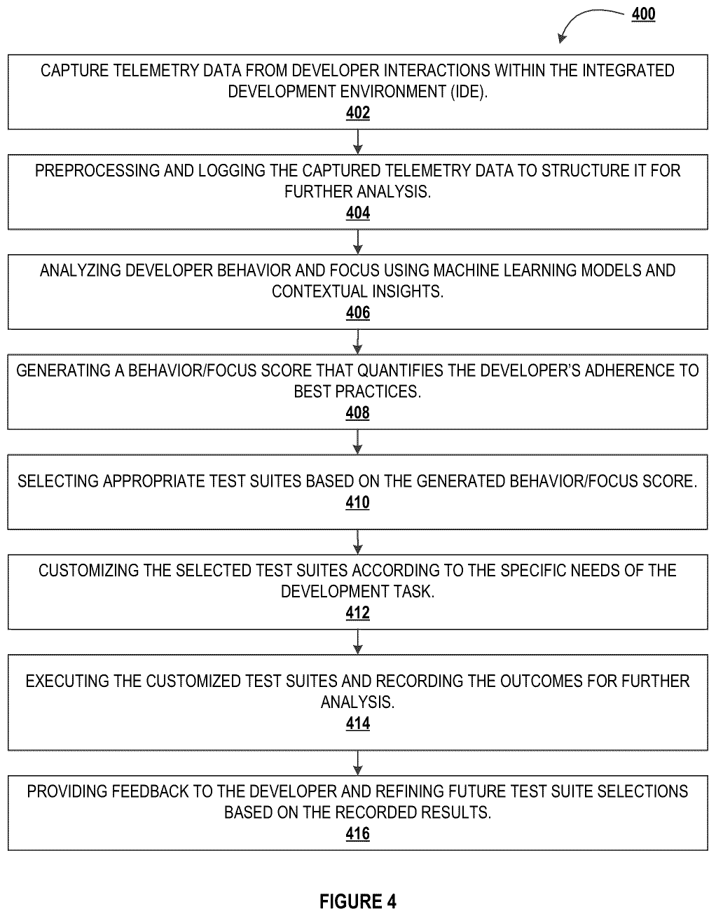

FIG. 4 illustrates a high-level process flow for code development in a distributed programming environment using programmer telemetry and developer behavior-focused test suite selection, in accordance with an embodiment of the disclosure. At step 402, the system captures telemetry data from developer interactions within the integrated development environment (IDE). This data includes various metrics such as code suggestions, refactoring actions, and error-handling recommendations, all of which provide insights into the developer's coding behavior. By monitoring these interactions in real-time, the system establishes a foundational dataset that will be used for subsequent analysis and decision-making.

In step 404, the captured telemetry data is preprocessed and logged to structure it for further analysis. This preprocessing phase includes filtering out noise, normalizing the data, and organizing it into a format suitable for in-depth analysis. Logging ensures that all relevant data points are systematically stored, enabling the system to maintain a comprehensive history of developer interactions for future reference. Moving to step 406, the preprocessed data is analyzed to discern the developer's behavior and focus levels. The system leverages machine learning models and contextual insights from the developer's coding history to assess patterns in their behavior. This analysis is crucial for identifying potential deviations from best practices and areas where the developer may need additional support or guidance.

At step 408, the system generates a behavior/focus score based on the analysis conducted in the previous step. This score is a quantitative measure of the developer's adherence to coding standards, security protocols, and overall focus during the coding process. A high score indicates strong alignment with best practices, while a lower score may flag potential issues that need to be addressed. In step 410, the system uses the behavior/focus score to select the most appropriate test suites from a repository. This selection process prioritizes tests that are most relevant to the developer's current coding patterns and potential vulnerabilities. By tailoring the test suite to the specific context of the code, the system enhances the efficiency and effectiveness of the testing process.

Step 412 involves customizing the selected test suites according to the specific needs of the development task. The system allows developers and testers to adjust test parameters, ensuring that the tests address any unique aspects of the code being developed. This customization step adds a layer of flexibility, enabling the system to adapt to a wide range of development environments and requirements. At step 414, the customized test suites are executed, and the results are recorded for further analysis. The system meticulously logs the outcomes of each test, providing a detailed record of any issues or errors identified during the testing phase. This execution and logging process is essential for maintaining a clear audit trail and for informing future test suite selections.

Finally, in step 416, the system provides feedback to the developer based on the results of the executed test suites. This feedback includes recommendations for further code adjustments or refactoring and may also trigger refinements in future test suite selections. By continuously refining the test selection process, the system ensures that it evolves alongside the developer's growing expertise and the increasing complexity of the code.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for code development in distributed programing environment using programmer telemetry and developer behavior-focus based test suite selection, the system comprising:
a processing device;
a non-transitory storage device containing instructions when executed by the processing device, causes the processing device to perform the steps of:
capturing telemetry data from a developer interaction within an integrated development environment (IDE), the telemetry data comprising metrics including code suggestions, refactoring actions, and error-handling recommendations;
preprocessing and logging the telemetry data in a format for further analysis by filtering noise from the telemetry data, normalizing the telemetry data, and organizing the telemetry data into a format suitable for analysis;
analyzing preprocessed data to discern developer behavior and focus levels via utilizing machine learning models and contextual insights related to a developer coding history;
generating a focus score based on analysis, the focus score quantifying an adherence to coding standards and security protocols;
selecting one or more test suites from a repository based on the focus score, wherein the one or more test suites are prioritized according to relevance to the developer current coding patterns and potential vulnerabilities;
customizing the one or more test suites by allowing modifications to test parameters addressing specific aspects of the code being developed;
executing the one or more test suites and recording outcomes to generate test results; and
providing feedback to the developer based on the test results, the feedback comprising recommendations for further code adjustments and triggering refinements in future test suite selections.

2. The system of claim 1, wherein the system is further configured to: generate a report including a detailed breakdown of the telemetry data, the focus score, and a rationale for the selection of the one or more test suites.

3. The system of claim 1, wherein the system is further configured to: continuously update the focus score in real-time as the developer interacts with the IDE, allowing for dynamic adjustments to the one or more test suites.

4. The system of claim 1, wherein the system is further configured to: utilize natural language processing (NLP) techniques to translate the telemetry data and analysis results into a human-readable format for review by the developer.

5. The system of claim 1, wherein the system is further configured to: adjust the focus score by incorporating feedback from previously executed test suites, refining an accuracy of future test suite selections.

6. The system of claim 1, wherein the system is further configured to: allow the developer to manually override the one or more test suites, providing options to add or remove specific tests.

7. The system of claim 1, wherein the system is further configured to: integrate with a version control system to track changes in the code over time and update the focus score and one or more test suites according to the changes in the code over time.

8. A computer program product for code development in distributed programing environment using programmer telemetry and developer behavior-focus based test suite selection, the computer program product comprising a non-transitory computer-readable medium comprising code causing an apparatus to:
capture telemetry data from a developer interaction within an integrated development environment (IDE), the telemetry data comprising metrics including code suggestions, refactoring actions, and error-handling recommendations;
preprocess and log the telemetry data in a format for further analysis by filtering noise from the telemetry data, normalizing the telemetry data, and organizing the telemetry data into a format suitable for analysis;
analyze preprocessed data to discern developer behavior and focus levels via utilizing machine learning models and contextual insights related to a developer coding history;
generate a focus score based on analysis, the focus score quantifying an adherence to coding standards and security protocols;
select one or more test suites from a repository based on the focus score, wherein the one or more test suites are prioritized according to relevance to the developer current coding patterns and potential vulnerabilities;
customize the one or more test suites by allowing modifications to test parameters addressing specific aspects of the code being developed;
execute the one or more test suites and recording outcomes to generate test results; and
provide feedback to the developer based on the test results, the feedback comprising recommendations for further code adjustments and triggering refinements in future test suite selections.

9. The computer program product of claim 8, wherein the code further causes the apparatus to: generate a report including a detailed breakdown of the telemetry data, the focus score, and a rationale for the selection of the one or more test suites.

10. The computer program product of claim 8, wherein the code further causes the apparatus to: continuously update the focus score in real-time as the developer interacts with the IDE, allowing for dynamic adjustments to the one or more test suites.

11. The computer program product of claim 8, wherein the code further causes the apparatus to: utilize natural language processing (NLP) techniques to translate the telemetry data and analysis results into a human-readable format for review by the developer.

12. The computer program product of claim 8, wherein the code further causes the apparatus to: adjust the focus score by incorporating feedback from previously executed test suites, refining an accuracy of future test suite selections.

13. The computer program product of claim 8, wherein the code further causes the apparatus to: allow the developer to manually override the one or more test suites, providing options to add or remove specific tests.

14. The computer program product of claim 8, wherein the code further causes the apparatus to: integrate with a version control system to track changes in the code over time and update the focus score and one or more test suites according to the changes in the code over time.

15. A method for code development in distributed programing environment using programmer telemetry and developer behavior-focus based test suite selection, the method comprising:
capturing telemetry data from a developer interaction within an integrated development environment (IDE), the telemetry data comprising metrics including code suggestions, refactoring actions, and error-handling recommendations;
preprocessing and logging the telemetry data in a format for further analysis by filtering noise from the telemetry data, normalizing the telemetry data, and organizing the telemetry data into a format suitable for analysis;
analyzing preprocessed data to discern developer behavior and focus levels via utilizing machine learning models and contextual insights related to a developer coding history;
generating a focus score based on analysis, the focus score quantifying an adherence to coding standards and security protocols;
selecting one or more test suites from a repository based on the focus score, wherein the one or more test suites are prioritized according to relevance to the developer current coding patterns and potential vulnerabilities;
customizing the one or more test suites by allowing modifications to test parameters addressing specific aspects of the code being developed;
executing the one or more test suites and recording outcomes to generate test results; and
providing feedback to the developer based on the test results, the feedback comprising recommendations for further code adjustments and triggering refinements in future test suite selections.

16. The method of claim 15, wherein the method further comprises: generate a report including a detailed breakdown of the telemetry data, the focus score, and a rationale for the selection of the one or more test suites.

17. The method of claim 15, wherein the method further comprises: continuously update the focus score in real-time as the developer interacts with the IDE, allowing for dynamic adjustments to the one or more test suites.

18. The method of claim 15, wherein the method further comprises: utilize natural language processing (NLP) techniques to translate the telemetry data and analysis results into a human-readable format for review by the developer.

19. The method of claim 15, wherein the method further comprises: adjust the focus score by incorporating feedback from previously executed test suites, refining an accuracy of future test suite selections.

20. The method of claim 15, wherein the method further comprises: allow the developer to manually override the one or more test suites, providing options to add or remove specific tests.
